(19) United States
(12) Patent Application Publication
(10) Pub. No.: US 2009/0045015 A1
(43) Pub. Date: Feb. 19, 2009

(54) PROCESS AND FIXTURE FOR INSTALLING, REMOVAL AND SERVICING OF WALL OR CEILING MOUNTED ELECTRONICS AND HARDWARE

(76) Inventors: Robert Anstead, San Juan Capistrano, CA (US); Marco Guerrero, San Juan Capistrano, CA (US)

Correspondence Address: Edward Kmett;Suite 1600, 650 Town Center Drive, Costa Mesa, CA, 92626, US

(21) Appl. No.: 12/187,247

(22) Filed: Aug. 6, 2008

Related U.S. Application Data
(60) Provisional application No. 60/964,192, filed on Aug. 8, 2007.

(51) Int. Cl. B66B 9/16; A47G 29/00

(52) U.S. Cl. 187/244; 248/370

(57) ABSTRACT

A portable apparatus for lifting a television to be mounted on a wall has a base frame assembly with at least three support members, and a connecting member that is connected to a first end of a first support member, and a first end of a second support member and a first end of a third support member are pivotally connected to the base frame support member. A mast assembly having at least two segments is removably connected to the connecting member of the base frame assembly, and a trolley device is removably engaged with the mast assembly, where the trolley is capable of translating along the length of the mast assembly. A electronic device holding assembly that has at least two support arms, and a cross-member to which the support arms are connected, is removably engaged with the trolley, and a driving mechanism causes the trolley to translate along the length of the mast assembly. Thus, a flat screen television can be readily installed on a wall by operating the apparatus of the invention.

### CROSS-REFERENCE TO RELATED APPLICATIONS

This application claims priority under 35 U.S.C. § 119(e) to U.S. Provisional Application No. 60/964,192, filed on Aug. 8, 2007, the contents of which are incorporated by reference as if set forth in full herein.

### BACKGROUND OF THE INVENTION

1. Field of the Invention

This present invention relates to a fixture used to install, remove or hold for servicing of wall or ceiling mounted electronics or other hardware. More particular, the invention relates to a lifting device for lifting electronic devices such as flat screen televisions and locating the electronic device against a wall or ceiling for easy installation or removal of the electronic device.

2. Related Background Art

Flat screen televisions have become common place household items, and it has become more and more popular to mount the flat screen television to a mounting bracket on a wall. Conventionally, when a flat screen television is to be mounted to a wall, the mounting bracket is first installed on the wall. The user then has to lift the flat screen television and align mounting holes in the television with mounting holes in the bracket and then attach the television to the mounting bracket. It is often difficult, however, for the user to be able to hold the television at the height of the wall-mounted bracket and align the holes while attempting to install fasteners in the holes. In addition, it is difficult for the user to be able to see whether or not the holes are aligned while they are holding the television because the clearance between the television and the wall is generally small.

Some mounting brackets may include two parts, one of which is first installed on the wall and the other of which is first installed on the back of the television. With this configuration, the mounting bracket may include some type of soft-docking device that allows the user to temporarily connect the two portions of the mounting bracket together so that the television hangs loosely from the wall-mounted portion. However, with this type of mounting bracket, the user still has to lift the television and make a blind attempt to align the soft-docking device.

In addition, with both of the forgoing conventional docking techniques, the problem is more pronounced when the size of the television increases. Depending on the size of the television, two persons may be required to lift the television to the level of the wall mount, and to attempt to align the television with the mounting bracket. The need for additional personnel to perform the installation/removal/servicing job adds unnecessary man-hours, thereby increasing the cost of the job and requiring the hiring of additional employees for the company performing the job.

It has also become more commonplace for flat screen televisions to be mounted above a fireplace in a home. When installing a flat screen television on a wall above a fireplace, several obstacles make the installation more difficult. First, many fireplaces have a hearth at their base that is raised above the floor level. A hearth typically extends more than one foot in length away from the wall and beyond the width of the fireplace opening. Second, many fireplaces include a mantle mounted on the wall above the fireplace. Both of these obstacles make is more difficult to install the flat screen television on a wall above a fireplace.

What is needed is a way to make installation of a flat screen television to a wall easier on the installer, as well as reducing the need for more than one person to have to be present in order to accomplish the installation.

### SUMMARY OF THE INVENTION

The present invention addresses the foregoing problems by providing a device which allows a single person to easily install a flat screen television to a wall, even when the size of the television is large or where it is being installed above a fireplace.

According to one aspect, the invention is directed to a portable apparatus for lifting an electronic device to be mounted on a wall or for removing the electronic device from the wall. The apparatus has a base frame assembly having at least three support members connectable to one another. For instance, a first one of the support members may include a connection means, such as a clevis, to which the first end of a second support member is connected, and to which the first end of a third support member is connected. The connection allows the second and third support members to pivot toward the first (middle) member so that the base frame assembly can be collapsed for transporting. A second end of each support member may include a caster so that the entire apparatus can be easily moved around a room.

The apparatus of the invention also includes a mast assembly connectable to the base frame assembly, an electronic device holding assembly connectable to the mast assembly in a manner that permits the electronic device holding assembly to translate along a length of the mast assembly, and a driving mechanism for causing the electronic device holding assembly to translate along the length of the mast assembly. The electronic device holding assembly is for supporting the television to be mounted to the wall and thus comprises at least two support arms and a cross-member connecting the support arms. The apparatus may also have a trolley device connected to the mast providing a means for the electronic device holding assembly to translate along the length of the mast. That is, the trolley may be installed over the mast and the electronic device holding assembly is connected to the trolley. Thus, the electronic device holding assembly can readily translate up and down along the mast.

One feature regarding the mast is that it is preferably constructed of multiple segments for easy buildup, teardown and transportation. That is, the length of the mast can be made of one segment, or two or more segments that are fitted together. With this arrangement, the length of the mast can be adjusted based on how high on the wall the television is being mounted. Additionally, the mast segments are easily removable from the base assembly and from one another. Thus, while the mast segments may be square in shape, the joint of the mast segments is preferably constructed of a cylindrical male/female type connection rather than a square male/female type connection. This arrangement allows provides the ability to easily breakdown and buildup the apparatus for transportation.

In driving the apparatus so as to raise and lower the television, a simple driving mechanism such as a winch, cable and pulley system can be used to cause the trolley to translate along the length of the mast. Alternatively, and if more accuracy may be desired, a motor may be connected to drive a cable/pulley system, or could be connected directly to the trolley itself. This latter arrangement could provide further advantages by allowing the installer to stand-off from the apparatus and view the television from behind in order to better guide the television onto the mounting bracket.

A further feature of the invention is that the base assembly includes a hearth accommodating portion. That is, a second end of the second and third support members can be offset with a curved portion so that it will readily fit around most common fireplace hearths to allow the apparatus to be moved closer to the wall when mounting a television above a fireplace.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a perspective view depicting one embodiment of a portable apparatus for lifting an electronic device according to the invention.

FIG. 2 is a top view depicting one embodiment of a portable apparatus for lifting an electronic device according to the invention.

FIG. 3 is a front view depicting one embodiment of a portable apparatus for lifting an electronic device according to the invention.

FIG. 4 is a side view depicting one embodiment of a portable apparatus for lifting an electronic device according to the invention.

FIG. 5 depicts a mast segment joint according to one embodiment of the invention.

FIG. 6 depicts a mast segment joint according to one embodiment of the invention.

FIG. 7 is a cross-sectional view of a female connecting member for a mast joint of the invention.

FIG. 8 is a cross-sectional view of a male connecting member for a mast joint of the invention.

FIG. 9 is a detailed view of the internal construction of a trolley utilized in the invention.

FIG. 10 depicts an electronic device holding assembly according to the invention.

FIG. 11 is a detailed view depicting the attachment of holding arms onto a cross member.

FIG. 12 is a perspective view depicting the apparatus of the invention with a television thereon in the lowered position.

FIG. 13 is a side view depicting the apparatus of the invention with a television thereon in the lowered position.

FIG. 14 is a perspective view depicting the apparatus of the invention with a television thereon in the raised position.

FIG. 15 is a side view depicting the apparatus of the invention with a television thereon in the raised position.

### DETAILED DESCRIPTION OF THE PREFERRED EMBODIMENTS

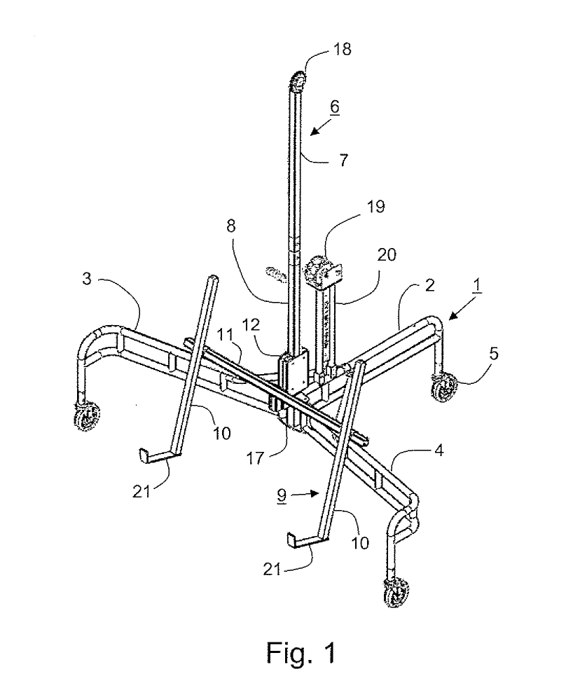

FIG. 1 is a perspective view depicting one embodiment of a portable apparatus for lifting an electronic device to be mounted on a wall or for removing the electronic device from the wall according to the invention. As seen in FIG. 1, the apparatus includes a base assembly 1, a mast assembly 6 and an electronic device holding assembly 9, each of which are connected together as will be described in detail below.

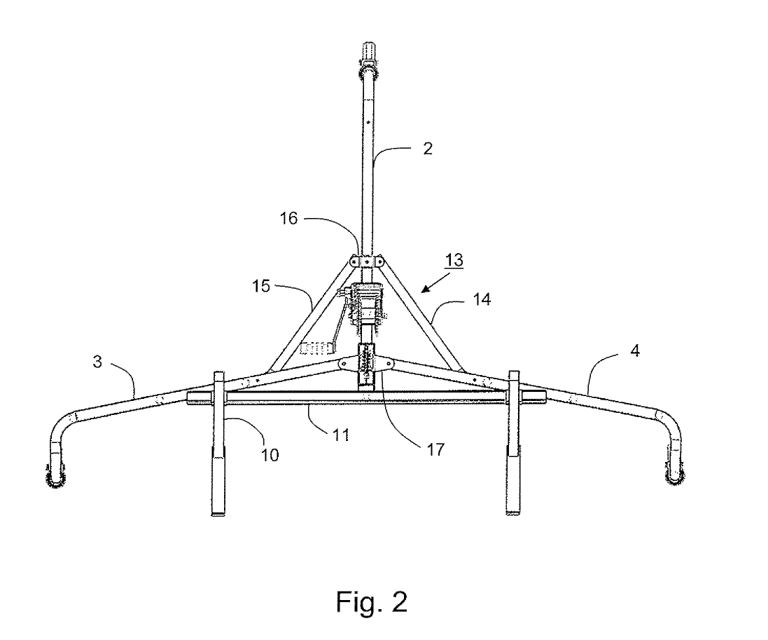

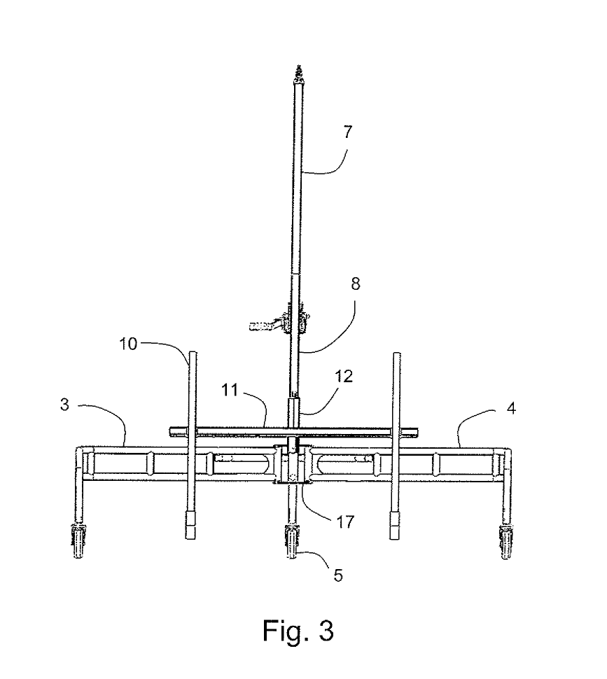

Base assembly 1 is seen to be comprised of three support members 2, 3 and 4, each of which are connectable with one another. In this regard, support member 2 is seen to be a relatively straight member with a caster 5 at one end. The opposing end of support member 2 includes a connecting clevis device 17 (see FIG. 2) for attaching support members 3 and 4 to support member 2. That is, support member 3 is attached to one portion of clevis 17 on support member 2 using, for example, a pin or bolt and nut arrangement. Support member 4 is likewise attached to another portion of clevis device 17 on support member 2. Thus, as seen in the figures, support members 3 and 4 may be minor images of one another. With support members 3 and 4 connected with clevis device 17 of support member 2, each of support members 3 and 4 can pivot so that they can be folded substantially parallel with support member 2. This provides the ability to fold the base member for easy transportation.

In order to hold support members 3 and 4 at a relatively fixed position during use of the apparatus, a brace assembly 13 is provided. Brace assembly 13 is seen to include two brace members 14 and 15 pivotally connected to a clevis/clamp device 16. The opposing end of each of brace members 14 and 15 are also pivotally connected to support members 3 and 4, respectively. Clevis/clamp device 16 is preferably constructed so that it slidably engages a top tubular portion of support member 2. That is, clevis/clamp device 16 may be a two part device that includes an insert that can slide along the surface of the tube on support member 2 so that, when folding the base assembly for transportation, the clevis is slid toward the caster end of support member 2 in order to fold support members 3 and 4. A pin (not shown) can be used to fix clevis/clamp device 16 at its built-up position and at its folded position. To build-up the base assembly from its folded position, the pin is removed from clevis/clamp device 16 and clevis/clamp device 16 is slid on the top tube of support member 2 toward the clevis 17 end of support member 2, and once support members 3 and 4 have been rotated to their built-up position, clevis/clamp device 16 may be locked in place by inserting the pin through clevis/clamp device 16 and a hole in the tube of support member 2.

Casters 5 on each of support members 2, 3 and 4 are preferably free rotating casters rather than being locked facing a particular direction. By providing free rotating casters, the apparatus can be more readily moved around a room. Of course, it is not necessary that all of casters 5 be free rotating. Rather, the casters installed on each of support members 3 and 4 could be fixed and locked to face a particular (forward) direction, while only caster 5 on support member 2 would be free rotating to provide the ability to steer the apparatus. Additionally, casters 5 preferably include a locking device (not shown) that can be locked to prevent the wheels of the caster from rolling.

Each of support members 2, 3 and 4 are preferably constructed of steel tubing with the various component parts being welded to form the respective support member. As seen in the figures, the steel tubing may be bent to shape the support members, and one end of the tubing may be bent to form legs into which casters 5 are installed. Each of support members 3 and 4 are also formed with a bent (offset) portion for accommodating the apparatus around a fireplace hearth. That is, the tubular structure of the support member is formed in a manner to allow the apparatus to negotiate a fireplace hearth (or any other obstacle) so that support members 3 and 4 can fit around the hearth and the apparatus can be moved closer to the wall when an electronic device is being installed above a fireplace. The amount of offset is a matter of design choice, but it is preferable to be at least one foot in length.

Clevis 17 at the end of support member 2 also includes a mast receiver portion (not shown). The mast receiver portion is preferably square in shape to accommodate a mast segment so that the mast segment may be slidably inserted into the mast receiver portion. The mast receiver portion also preferably includes a stop or bottom so that the mast segment, when inserted into the receiver portion, bottoms out on the stop or bottom. In practice, clevis 17 is formed with the mast receiver portion in the middle, and clevis portions for pivotally attaching the support member thereto on either side of the mast receiver portion. Clevis 17 can be welded or otherwise fixed to the end of support member 2.

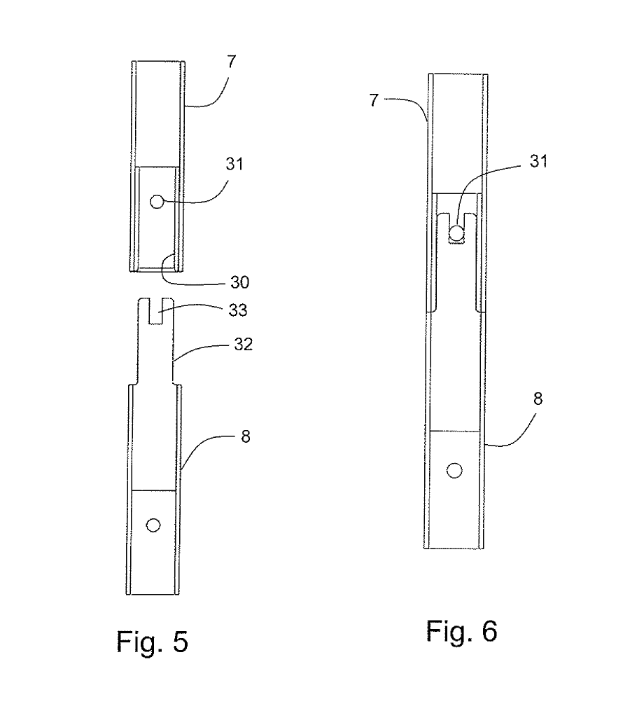

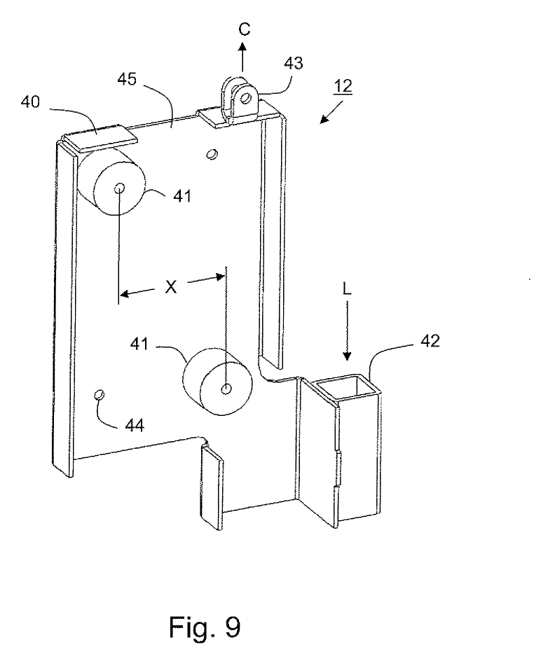

Referring again to FIG. 1, the apparatus of the invention is seen to include mast assembly 6. Mast assembly 6 is seen to be comprised of mast segments 7 and 8, which slidably engage one another in a manner described below. Mast segment 7 includes a pulley 18 at the top end of the segment. Pulley 18 accommodates a cable for raising an lowering the electronic device holding assembly 9 (to be described below). The end of mast segment 7 opposite pulley 18 includes either a male-type or female-type connector for connecting mast segment 7 with mast segment 8. In this regard, FIGS. 5 to 8 show one example embodiment of a cylindrical male/female-type connection for mast segments 7 and 8.

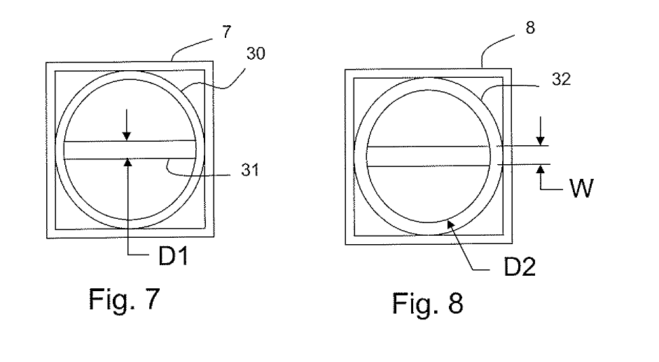

As seen in FIG. 5, mast segment 7 is seen to include a cylindrical female-type connection portion, while mast segment 8 is seen to include a cylindrical male-type connecting portion. In the embodiment shown in FIG. 5, both mast segments 7 and 8 are made of a square steel construction. In forming the cylindrical female-type connecting portion of mast segment 7, a cylindrical tube 30 is installed within the square inner cavity of segment 7. The cylindrical tube 30 may be secured by welding the tube within the square cavity. Prior to installing tube 30 into mast segment 7, a pin 31 is installed in tube 30. In this regard, pin 31 is preferably a solid cylindrical pin that may be installed through holes in tube 30 by welding the pin 31 to tube 30. FIG. 7 is a cross-sectional view of mast segment 7 through tube 30 and pin 31. The diameter D1 of pin 31 is a matter of design choice and no particular diameter is necessary.

Referring back to FIG. 5, mast segment 8 is seen to include a cylindrical male-type connecting portion. The cylindrical male-type connecting portion is seen to include a probe 32. Probe 32 is preferably a solid cylindrical bar that is inserted into the square inner cavity of mast segment 8. The probe, like tube 30, is secured within the square inner cavity by welding the probe to the segment 8. Probe 32 is seen to include a stepped-down diameter D2, which is slightly smaller than the inner diameter of tube 30 so that probe 32 can slidably fit within tube 30. In addition, the end of probe 32 includes a slot 33. The width (W) of slot 33 is slightly larger than the diameter D1 of pin 31, and the depth of slot 33 is such that, when mast segment 7 and mast segment 8 are fully engaged, a slight clearance will be present between pin 31 and the bottom of slot 33, as seen in FIG. 6.

Thus, the cylindrical connecting members (tube 30 and probe 32) formed within the square inner cavities of the mast segments 7 and 8 provide the ability to easily connect and disconnect the mast segments, while at the same time, retaining the structural integrity of the joint. In assembling the mast assembly 6 to base assembly 1, the bottom portion of mast segment 8 is inserted into the mast receiver portion of clevis 17 on support member 2 until it bottoms out. Then, as will be described in more detail below, trolley 12 is installed over mast segment 7, and finally, the female-type connecting member of mast segment 7 is engaged with the male-type connecting member of mast segment 8 by sliding the two segments together until mast segment 7 seats onto segment 8 as seen in FIG. 6.

It can readily be recognized that the mast assembly could be constructed of more segments besides mast segments 7 and 8. For instance, an extension member (not shown) may be inserted between mast segments 7 and 8 in order to increase the length of the mast assembly for installing an electronic device higher on a wall. In this case, it may also be preferable to include a ballast or balancing weight at or near the leg of support member 2 as needed to reduce the possibility of an imbalance of the apparatus when a heavy electronic device is being installed at a greater height.

FIG. 9 is a detailed view of the internal construction of a trolley utilized in the invention with a cover (not shown) having been removed to reveal the details. As seen in FIG. 9, trolley 12 is seen to include two wheels 41 installed in a housing 40. Each of wheels 41 are installed on a shaft (not shown) so that they can freely rotate. It should be noted that, while only two wheels 41 are shown in FIG. 9, more than two wheels (e.g., four wheels) could be utilized instead. Regardless of the number of wheels used, the space X between the shafts should be such that, in conjunction with the diameter of the wheels used, the width of mast segments 7 and 8 can be accommodated such that the trolley is installed substantially perpendicular to direction X.

Trolley 12 is also seen to include a clevis 43 installed on housing 40. Clevis 43, as will be described in more detail below, is utilized to connect a cable for raising and lowering the trolley, and preferably includes a hole for inserting a pin to connect the cable to the trolley. Holes 44 in housing 40 can be utilized for installing bolts and spacers to assemble a cover (not shown) so as to enclose trolley 12. A cutout area 45 is included in housing 40 to allow the trolley to be installed on mast segments 7 and 8.

Trolley 12 is also seen to include an electronic device holding assembly mounting member 42. Mounting member 42 is preferably a hollow square steel tube that is welded to housing 40. As will be described in more detail below, mounting member 42 accepts a male member 50 connected to electronic device holding assembly 9 so that assembly 9 can be removably mounted to the trolley.

It should also be noted that the location of wheels 41 within trolley 12 are such that the top wheel is located to the rear of the trolley 12 and the bottom wheel is located to the front of trolley 12, where the front is considered the side where mounting member 42 is located. That is, in operation, a cable connected to clevis 43 will provide a load C on clevis 43, while the electronic device holding assembly 9 will apply a load L on mounting member 42. These two forces result in a clockwise moment (as seen in relation to FIG. 9) being applied about the mast member and this moment is counteracted by the wheels being installed as shown in FIG. 9. Thus, while two additional wheels could be installed within trolley 12, the load on these additional wheels would generally be negligible and the additional wheels would merely provide better centering of the trolley along the surfaces of the mast.

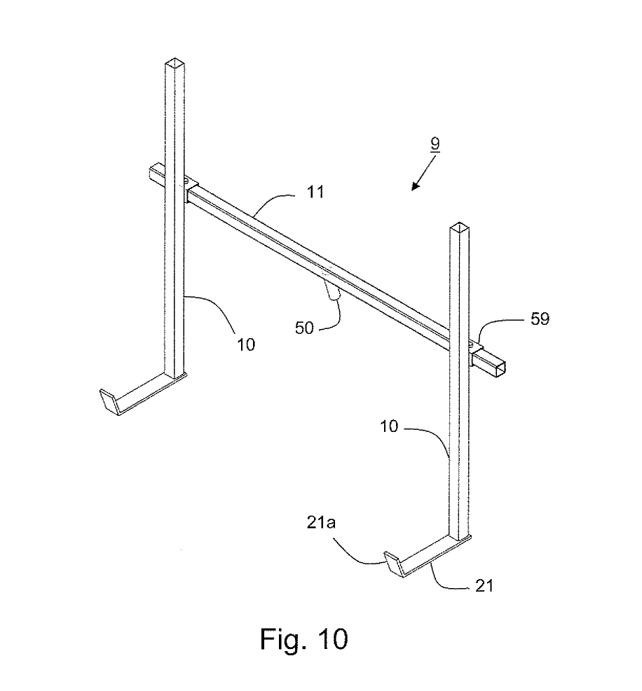

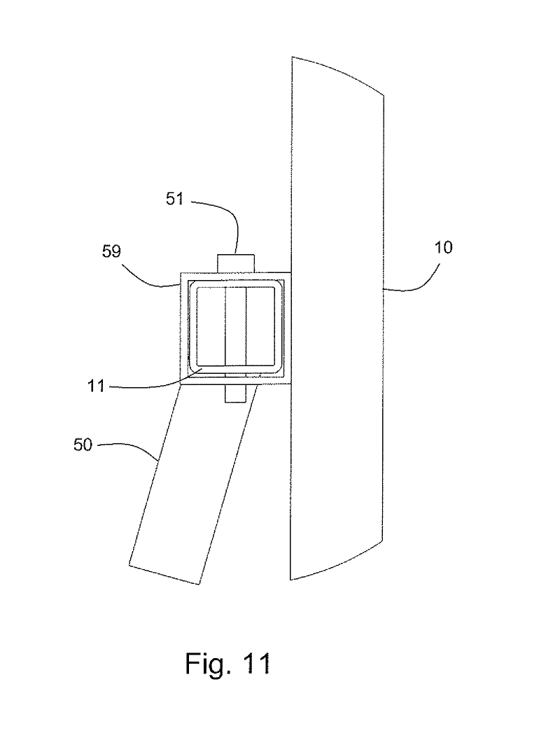

Referring back again to FIG. 1, the apparatus of the invention also includes an electronic device holding assembly 9, which is shown in detail in FIG. 10. Holding assembly 9 is seen to include two holding arms 10 and a cross-member 11. Holding arms 10 are seen to include hands 21 that may include fingers 21a for holding an electronic device, such as a flat screen television. Arms 10 are also seen to include an arm mounting member 59 for mounting arms 10 to cross-member 11. Arm mounting member 59 is preferably a hollow square tube welded to arm 10. Arms 10 are mounted to cross-member 11, preferably by sliding cross-member 11 through arm mounting member 59 and inserting a pin 51 (see FIG. 11) through holes in arm mounting member 59 and cross-member 11. In this regard, cross member 11 preferably includes a plurality of pin holes (not shown) across its length so that the distance between arms 10 can be adjusted according to the size of the electronic device being mounted to the wall. That is, for smaller electronic devices, arms 10 can be installed closer to one another using the pins 51, and for larger electronic devices, arms 10 can be installed farther apart from one another.

Cross-member 11 includes a male-type mounting post 50 for connecting the electronic device holding assembly to trolley 12. Mounting post 50 is preferably welded to cross-member 11 at or near the mid-point along the length of cross-member 11, and may be either square or cylindrical in shape. In addition, as seen in FIGS. 10 and 11, cross-member 11 and mounting post 50 are joined (welded) at an angle so that arms 10 can be installed at an angle to help hold the electronic device in the arms 10. No particular angle is necessary and the angle chosen is a matter of design choice. However, it is preferable that fingers 21a be designed so that they are substantially parallel to the wall. That is, fingers 21a may act as a stopping mechanism by bumping against the wall and as such, may include a soft material or bumper on their outer surface so as to reduce the possibility of damaging the wall.

When the cross-member 11 is to be installed on the apparatus of the invention, mounting post 50 is inserted into mounting member 42 on trolley 12. Thus, the external dimensions of mounting post 50 should be such that mounting post 50 and mounting member 42 slidably engage one another with a snug fit. The slidably-snug fit allows easy assembly/disassembly of the electronic device holding assembly from the trolley for easy buildup and teardown of the apparatus.

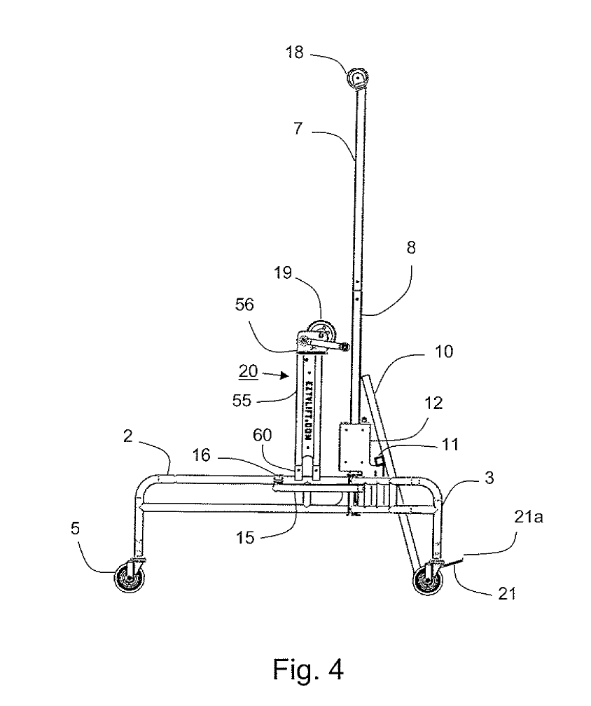

Referring once again to FIG. 1, the apparatus of the invention is seen to include a winch assembly, constituted by winch 19 and winch mounting post 20. In the figures, winch 19 is seen to be a manually-cranked hand winch which operates a metal cable (not shown). The metal cable is wrapped around a drum of winch 19, and is fed through pulley 18 atop of mast member 7, and is then connected to clevis 43 of trolley 12. In connecting the cable to clevis 43, the end of the cable may be formed into an eyelet which is inserted into the clevis such that a pin can be inserted through the hole of clevis 43 to connect the cable to the clevis 43. This arrangement provides for driving the trolley up and down along the mast so that the television may be raised and lowered to be installed on the wall. Of course, other types of winches or devices could be used instead to drive the trolley, some of which will be discussed below. In FIG. 4, winch mounting post 20 is seen to be formed of two cylindrical metal tubes 55 that are welded to a winch mounting plate 56. Winch 19 can be mounted to mounting plate 56 in any conventional manner, including being bolted to the plate.

Each of metal tubes 55 are inserted into receptacles 60, which are preferably welded to the top tube of support member 2. Receptacles 60 are preferably hollow tubes (either square or cylindrical) into which metals tubes 55 are inserted. Metal tubes 55 are then secured within receptacles 60 using, for example, pins.

The apparatus of the invention is designed to be portable. That is, the apparatus is designed to be readily disassembled for transportation by an installer to the location (e.g., home or business) where the television is to be installed. Thus, in packaging the apparatus for transportation, electronic device holding assembly 9 is removed from trolley 12. Arms 10 are removed from cross-member 11 by removing pins 51. The arms and cross-member can then be packaged into a carrying case for transportation.

The winch cable (not shown) is disconnected from clevis 43 of trolley 12 and wound onto a drum of winch 19, or otherwise stored for transportation. In this regard, winch mounting posts 20 may be connected with a plate to which two spindles may be installed and the cable may be wound around the spindles for transportation. Mast segment 7 is removed from its connection with mast segment 8, trolley 12 is slid off of mast segment 8 and then mast segment 8 is removed from its connection with the mast receiver of clevis 17 on support member 2. Winch mounting post 20 is removed from receptacles 60 by removing the connecting pins. The mast segments and winch assembly can then be placed in a carrying case for transportation.

Finally, base assembly 1 is collapsed by removing the retaining pin from clevis/clamp device 16 from its connection with support member 2. Clevis/clamp device 16 is then slid towards caster 5 on support member 2 so that support members 3 and 4 rotate about their pinned joint at clevis device 17. Thus, support members 3 and 4 are folded so that they are roughly parallel to support member 2. The pin can then be inserted through clevis/clamp device 16 and a hole in support member 2 near the caster-end to retain the base assembly in the folded position. The base assembly, in its folded position, can then be placed in a carrying case for transportation.

After arriving at the location for installing the television, the installer can easily build-up the apparatus of the invention on-site. In this regard, the installer removes the base assembly from its carrying case, removes the pin from clevis/clamp device 16, slides clevis/clamp device 16 forward to extend support members 3 and 4 and then inserts the pin in clevis/clamp device 16 and the hole in support member 2 at the extended position. The installer then installs mast segment 8 it into its attachment at clevis 17 of support member 2. The trolley is then placed over mast segment 8 and mast segment 7 is then installed into its mating connection with mast segment 8. Cross-member 11 and arms 10 are assembled using pins 51 and the electronic device holding assembly is installed into mounting member 42 on trolley 12 via member 50. Finally, the winch support post 20 is installed in receptacles 60 and pins are installed to retain the winch support post in place. The winch cable is then fed onto pulley 18 and connected with clevis 43 of trolley 12 using a pin. The apparatus of the invention is thus ready for use to install a television.

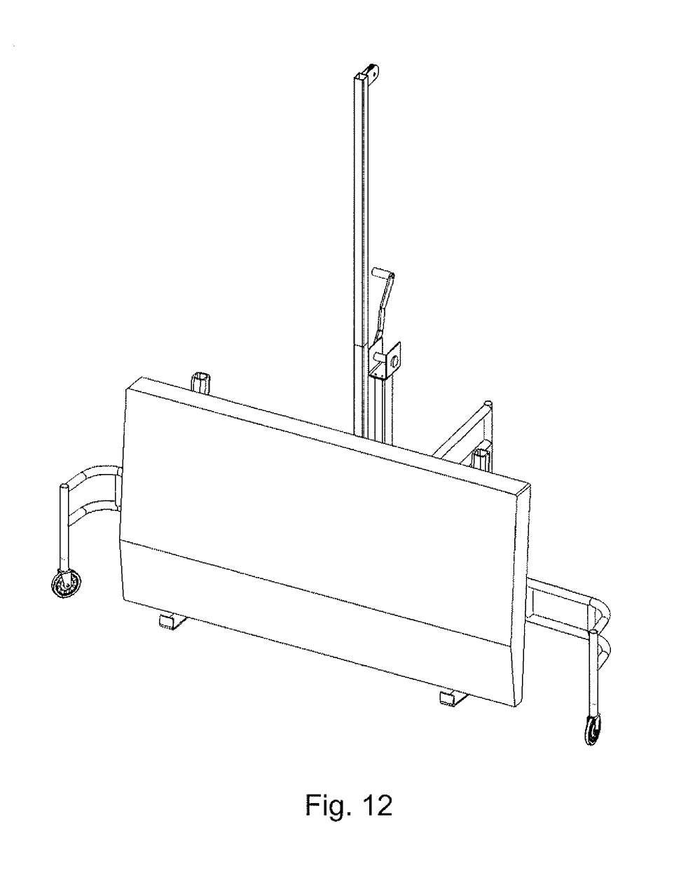

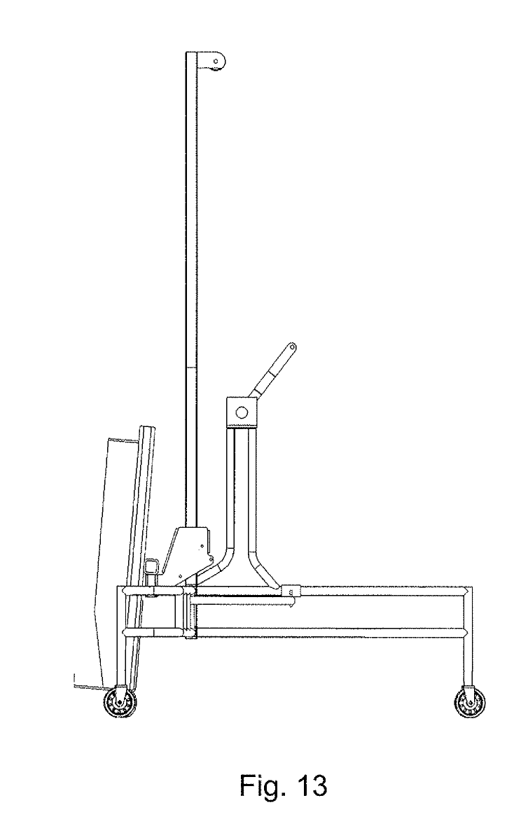

FIG. 12 is a perspective view and FIG. 13 is a side view depicting the apparatus of the invention with a television placed thereon in the lowered position. As seen in the figures, the television to be installed is a flat screen television. To install the television using the apparatus of the invention, the television is placed in the arms 10. Prior to placing the television on arms 10, the width of the arms are adjusted according to the size of the television. That is, the installer removes pins 51 connecting arms 10 to cross-member 11 and then reinstalls the arms 10 in one of the plurality of holes in cross-member 11 using pin 51 so that the arms are installed at an appropriate width for the television. In addition, in determining an appropriate width for arms 10, the installer may take into consideration the location of electronic wiring connections on the bottom of the television so that hands 21 of arms 10 do not overlap the connections, thereby permitting the installer to connect electrical wiring (e.g., HDMI cables, DVI cables, component video cables, audio cables, etc.) to the television. While not shown in the figures, a strap (e.g., a velcro strap) may be wrapped around the television and arms 10 to better secure the television to the arms.

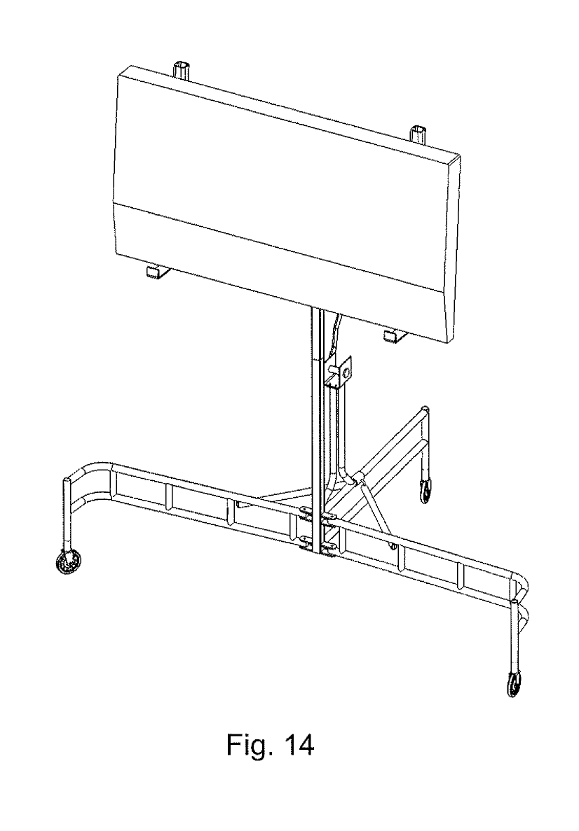

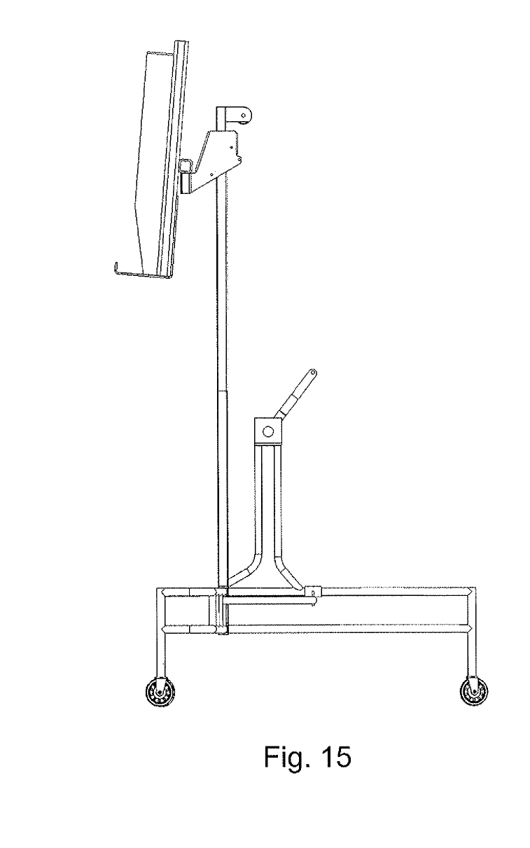

FIG. 14 is a perspective view and FIG. 15 is a side view depicting the apparatus of the invention with a television thereon in the raised position. In this regard, to raise the television, the installer operates the winch until the television is at a desired height for the installation. The installer can then move the apparatus towards the wall (and the corresponding wall mount for the television, which was previously installed on the wall). Upon approaching the wall mount, the installer can place the apparatus near the wall, but far enough away so that the television has not yet engaged the wall mounting bracket. With the television at this position, the installer can easily access the electronic wiring connections on the bottom or rear of the television and make the necessary wiring connections. Thus, the apparatus of the invention aids the installer by holding the television at the desired height and providing easy access to the wiring connections. Once the wiring connections have be completed, the installer can move and raise/lower the apparatus as needed to engage the wall mounting bracket. Once the television has been engaged with the wall mounting bracket, the installer can the disengage the apparatus by lowering the electronic device holding assembly using the winch and then backing the apparatus away from the wall.

As can be seen from the foregoing, the apparatus of the invention provides the ability for a single installer to be able to install a large flat screen television to a wall without the need for assistance from an additional installer. In addition, if the television is being installed over a fireplace that has hearth, the hearth accommodating portion of support members 3 and 4 allow the device to easily negotiate around the hearth so that the apparatus can be moved closer to the wall to engage the wall mounting bracket.

While the invention has been described with particular embodiments, those skilled in the art can readily understand that various modifications and changes could be implemented without departing from the scope of the invention. For example, while the manually-actuated winch depicted and described herein acts as a driving mechanism for raising and lowering the apparatus, it can be understood that other types of driving mechanisms could be employed instead. For instance, rather than a manually-actuated winch, a motorized winch could be implemented instead. The use of a motorized winch may provide some additional advantages in that it could be remotely controlled by the installer. That is, a motorized winch could include a control device (either wired or wireless) that the installer could operate while standing off to the side of the apparatus, thereby permitting the installer to have a better view of the engagement of the television with the wall mounting bracket while remotely operating the winch. Thus, while a manually-actuated winch would be acceptable and less costly than a motorized winch, some installers may desire the convenience of the motorized winch instead.

Of course, a winch itself is not necessary to actuate the apparatus and other types of driving mechanisms could be employed. For example, rather than the winch assembly in which a cable moves the trolley up and down along the mast, the trolley itself could include a driving mechanism. For instance, a motor may be connected to the trolley to drive one or more of wheels 41. This type of arrangement may require the use of opposing wheels so that sufficient traction can be obtained by the driving wheel. In addition, rather than utilizing a friction wheel driven by a motor, gears could be implemented instead, where at least one of the gears would be a driving (pinion) gear that is motor-driven, and a rack gear may be installed along the surface of the mast segments. Thus, it can be seen that various embodiments for driving the trolley could be implemented without departing from the scope of the invention.

In addition, while the base assembly depicted and described herein includes three support members, it can readily be understood that more than three support members could be implemented instead. The inventors herein, however, have found that three support members provide the desired amount of stability for the apparatus and also reduce the weight of the apparatus for easier transportation.

Further, while the mast assembly depicted herein has been depicted with two mast segments, more than two, or less than two segments could be implemented instead. Additionally, while the mast segments depicted herein as shown to have a square cross-section, other types of mast segments could be implemented instead. For instance, rather than a square cross-section for the mast segments, a circular or round cross-section could be used for the mast segments. In such a case, the trolley and the wheels within the trolley would need to be designed accordingly to accommodate the particular mast segment cross-section.

As those skilled in the art would readily recognize, other changes and modifications could be made to the assembly of the invention without departing from the scope of the invention.

What is claimed is:

1. A portable apparatus for lifting an electronic device to be mounted on a wall or for removing the electronic device from the wall, comprising:
a base frame assembly comprising at least three support members, and a connecting member that is connected to a first end of a first support member among the at least three support members, wherein a first end of a second support member among the at least three support members, and a first end of a third support member among the at least three support members, are pivotally connected to the base frame support member;
a mast assembly removably connectable to the base frame assembly;
an electronic device holding assembly removably connectable to the mast assembly in a manner that permits the electronic device holding assembly to translate linearly along a length of the mast assembly; and
a driving mechanism for causing the electronic device holding assembly to translate along the length of the mast assembly.

2. The apparatus according to claim 1, further comprising a base frame support member brace assembly slidably connected to the first support member and pivotally connected to each of the second and third support members.

3. The apparatus according to claim 1, wherein each of the first, second and third support members includes a caster mounted to a second end of the respective support member.

4. The apparatus according to claim 1, wherein the connecting member of the base frame assembly includes a mast connecting portion for connecting the mast assembly to the base frame assembly.

5. The apparatus according to claim 1, wherein the electronic device holding assembly comprises:
at least two support arms; and
a cross-member to which the support arms are connected,
wherein the support arms are arranged to hold the electronic device.

6. The apparatus according to claim 1 further comprising a trolley device connected to the electronic device holding assembly, the trolley device being installed on the mast assembly and providing a means for the electronic device holding assembly to translate along the length of the mast assembly.

7. The apparatus according to claim 6, wherein the mast assembly is comprised of at least two mast segments removably connected with each other.

8. The apparatus according to claim 7, wherein the each of the mast segments have a square outer cross section, and a first end of a first one of the mast segment includes a cylindrical-shaped male-type connection member and a first end of a second one of the mast segments includes a cylindrical-shaped female-type connection member that connects with the male-type connection member of the first mast segment to connect the two mast segments together.

9. The apparatus according to claim 6, wherein the driving mechanism comprises a winch, cable and pulley system arranged to cause the trolley to translate along the length of the mast.

10. The apparatus according to claim 9, wherein the winch is driven by a motor.

11. The apparatus according to claim 1, wherein the first support member of the base assembly is substantially linear, and a second end of each of the second and third support members is formed with an offset portion in a forward direction of the apparatus.

12. A portable apparatus for lifting an electronic device to be mounted on a wall or for removing the electronic device from the wall, comprising:
a base frame assembly comprising at least three support members, and a connecting member that is connected to a first end of a first support member among the at least three support members, wherein a first end of a second support member among the at least three support members, and a first end of a third support member among the at least three support members, are pivotally connected to the base frame support member;
a mast assembly removably connected to the connecting member of the base frame assembly, wherein the mast assembly is comprised of at least two mast segments removably connected with each other;
a trolley device removably engaged with the mast assembly, the trolley being capable of translating along the length of the mast assembly;
an electronic device holding assembly removably connected to the trolley device, the electronic device holding assembly being comprised of at least two support arms, and a cross-member to which the support arms are connected, wherein the support arms are arranged to hold the electronic device; and
a driving mechanism for causing the trolley to translate along the length of the mast assembly.

13. The apparatus according to claim 12, wherein the each of the mast segments have a square outer cross section, and a first end of a first one of the mast segment includes a cylindrical-shaped male-type connection member and a first end of a second one of the mast segments includes a cylindrical-shaped female-type connection member that connects with the male-type connection member of the first mast segment to connect the two mast segments together.
